(19) United States
(12) Patent Application Publication
(10) Pub. No.: US 2015/0138605 A1
(43) Pub. Date: May 21, 2015

(54) SYSTEMS AND METHODS FOR ADDING COMMERCIAL CONTENT TO PRINTOUTS

(71) Applicants: Samson J. Liu, Mountain View, CA (US); Parag M. Joshi, Los Gatos, CA (US); Sheng-Wen Yang, Beijing (CN); Jian-Ming Jin, Beijing (CN)

(72) Inventors: Samson J. Liu, Mountain View, CA (US); Parag M. Joshi, Los Gatos, CA (US); Sheng-Wen Yang, Beijing (CN); Jian-Ming Jin, Beijing (CN)

(21) Appl. No.: 13/821,356

(22) PCT Filed: Sep. 21, 2010
(86) PCT No.: PCT/CN2010/001453

§ 371 Date: Mar. 7, 2013

(51) Int. Cl. G06Q 30/02; G06F 3/12; G06K 15/02

(52) U.S. Cl. CPC G06Q 30/0251; G06K 15/1822; G06K 15/1809; G06F 3/1243; G06F 3/1289
USPC 358/3.24

(57) ABSTRACT

Systems, devices and methods are provided which relate to detecting a print command on a client computer, the print command reflecting an interest to print content of an electronic document, accessible by a client computer, as a hard copy printout. One method includes analyzing the electronic document content to determine its underlying subject matter, identifying commercial content relevant to the underlying subject matter, and creating and formatting a new, printable document that includes the electronic document content and the identified commercial content.

### BACKGROUND

Although targeted advertising is common on the World Wide Web, such advertising may have little lasting impact on the web user given that the advertising is often quickly replaced with other web content as the user surfs from electronic document to electronic document. Of potentially greater value would be commercial content that is of a more permanent nature than electronic documents, and therefore more likely to be noticed and acted upon by a user.

### BRIEF DESCRIPTION OF THE DRAWINGS

The disclosed systems and methods can be better understood with reference to the following drawings. The components in the drawings are not necessarily to scale.

FIG. 1 is a schematic view of an example of a system with which commercial content can be added to electronic document printouts.

FIG. 2 is a block diagram of an example of a client computer shown in FIG.

FIG. 3 is a block diagram of an example of a server computer shown in FIG. 1.

FIG. 4 is a flow diagram that illustrates an example of a method for adding commercial content to an electronic document printout.

FIG. 5 is a flow diagram that illustrates an example of a client-centric method for adding commercial content to an electronic document printout.

FIG. 6 is a flow diagram that illustrates an example of a server-centric method for adding commercial content to an electronic document printout.

FIG. 7A is a schematic view of an example of a conventional web printout.

FIG. 7B is a schematic view of an example of an electronic document printout that can result when the disclosed systems and methods are used to reformat an electronic document and add commercial content to create a new, printable electronic document.

### DETAILED DESCRIPTION

As described above, existing online targeted advertising may have little lasting impact on the typical web user. Moreover, many electronically exchanged documents, including both text and image documents, contain little or no commercial content. Therefore, it can be appreciated that it would be desirable to have a system or method for providing relevant commercial content, not originally associated with an electronic document, for users. Disclosed herein are systems and methods that achieve that goal by adding commercial content to electronic document printouts. This can include adding commercial content to documents that result when an electronic document, accessible from a client computer by a network link, is printed by a user. This can also include adding commercial content to electronic word processing documents, PDFs, image files and the like, when the same are printed by a user.

In some examples, the electronic document content that the user has accessed and presumably may chose to preserve by printing, e.g., PDF, word processing document, image file, eta, is identified and analyzed to determine its underlying subject matter and/or a taxonomic analysis to determiner information. Next, commercial content, such as advertisements and/or coupons, pertinent to the underlying subject matter is identified, based on using meta-data associated with the various commercial content in a commercial content database including location, demographic, revenue and the like meta-data, to select relevant commercial content to add to the new, printable electronic document. Once the commercial content has been identified, a new, printable document is created and formatted for printing that comprises both the electronic document content and the commercial content, which may be formatted for unobtrusive placement on the printed page. In some examples, the new, printable document for printing may exclude content that the user does not wish to preserve in a printout. e.g., footers, headers, source formatting, comments and/or annotations, citations, web site navigation features, hyperlinks to other web pages, and online advertisements, and the like. By filtering such content, a printout having improved formatting and less clutter results, even though new, additional commercial content has been added.

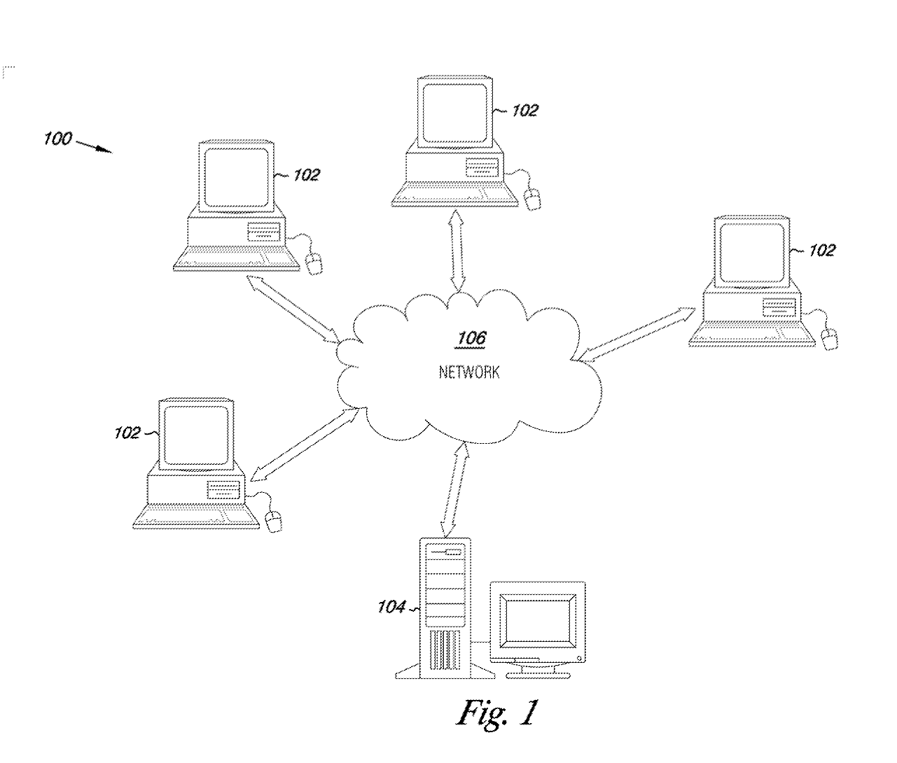

Referring now in more detail to the drawings, in which like numerals indicate corresponding parts throughout the several views, FIG. 1 illustrates an example of a network system 100. As indicated in that figure, the system 100 can include a number of network accessible devices, e.g., client computers 102, and at least one networked server computer 104. In the example of FIG. 1, the client computers 102 are illustrated as personal computers (PCs) that are configured to communicate with the server computer 104 via a network 106, which in some examples comprises the Internet but can also include wired and wireless local area networks (LANs) and wide area networks (WANs) connected through a number of different protocols. Although PCs are illustrated in FIG. 1 by way of example, it is to be appreciated that substantially any network-enabled device could be used, including notebook computers, handheld computers, mobile telephones, media players, gaming consoles, and the like. In addition to communicating with the server computer 104, the client computers 102 can also access electronic documents in the form of word processing documents, images and graphics, PDFs, video files, audio files, and web content, for example in the form of web sites and web pages, via the network 106 using an appropriate program, peer to peer file sharing, fttp, TCP/IP, and/or using a network browser.

As described in greater detail below, the server computer 104 is, in some examples, configured to identify relevant electronic document content that is to be printed and further to identify commercial content that is to be added to the relevant electronic document content to printout. Ire some examples, the sever computer 104 can be configured to create and format a new, printable document that can be used to generate a printout. In some examples, the server computer 104 is further configured to filter out at least some of the electronic document content, e.g., footers headers, source formatting, comments and/or annotations, citations, image or photo background, web site navigation features, hyperlinks to other web pages, and online advertisements, and the like to improve printout format and reduce printout clutter.

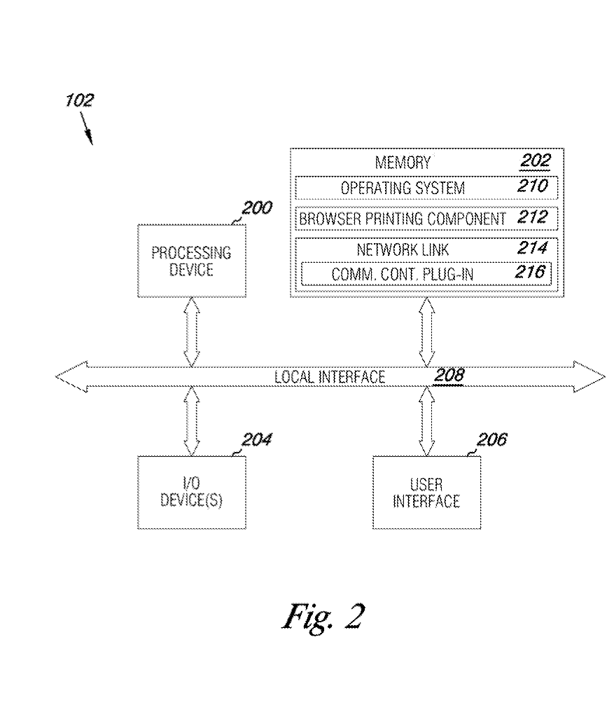

FIG. 2 is a block diagram illustrating an example architecture for one of the network accessible devices, e.g., client computers 102. The computer 102 of FIG. 2 comprises a processing device 200, memory 202, a user interface 204, and at least one I/O device 206, each of which is connected to a local interface 208.

The processing device 200 can include one or more processors associated with the computer 102, e.g., a semiconductor based microprocessor (in the form of a microchip), and/or can include hardware processing resources in the form of an application specific integrated circuit (ASIC). The memory 202 includes any one of or a combination of volatile memory elements (e.g., RAM) and nonvolatile memory elements (e.g., hard disk, flash memory, ROM, tape, etc.).

The user interface 204 comprises the components with which a user interacts with the computer 102. The user interface 204 may comprise, for example, a keyboard, mouse, touchscreen, and a display, such as a cathode ray tube (CRT) or liquid crystal display (LCD) monitor. The one or more I/O devices 206 are adapted to facilitate communications with other devices and may include one or more communication components such as a modulator/demodulator (e.g., modem), wireless (e.g., radio frequency (RF)) transceiver, network card, etc.

The memory 202 comprises various programs including an operating system 210, a browser printing component 212, and a network link 214. The operating system 210 controls the execution of other programs and provides scheduling, input-output control, file and data management, memory management, and communication control and related services. The browser printing component 212 is configured to translate content from user applications, such as word processing applications, file sharing applications, a network browser, and the like accessible over a network link 214, into print content that can be transmitted to an appropriate printing device for the generation of a hard copy printout. The network link 214 is a program that is configured to access and display network content. The network link 214 is used to access, display, and edit electronic documents (image or text content), browse the World Wide Web (“the web”) over the Internet, etc.

In the example of FIG. 2, the network link 214 includes a commercial content plug-in 216 that is configured to automatically add commercial content to printouts of electronic document content. As described in greater detail below, the plug-in 216 can be configured to analyze the electronic document content to determine t underlying subject matter or taxonomy information to enable selection of appropriate commercial content to add, or to at least identify the relevant electronic document content to another device (e.g., a remote add server such as server computer 104 in FIG. 1) that can perform such analysis.

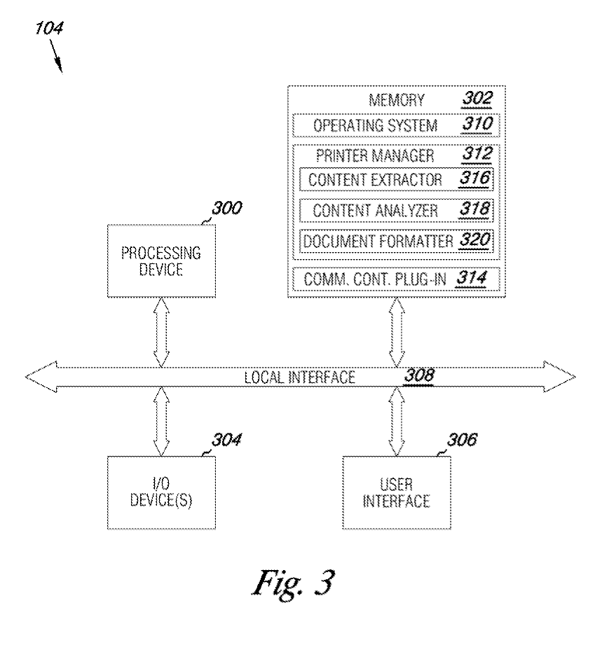

FIG. 3 is a block diagram illustrating an example architecture for the server computer 104, e.g., add server, shown in FIG. 1. As indicated in FIG. 3, the server computer 104 comprises many of the same components as the client computer 102 shown in FIG. 2, including a processing device 300, memory 302, a user interface 304, and at least one I/O device 306, each of which is connected to a local interface 308. In some examples, those components have the same or similar construction and/or function of like-named components described above in relation to FIG. 2. Accordingly, a detailed discussion of the components of FIG. 3 is not presented herein.

As indicated in FIG. 3, the memory 302 of the server computer 104 comprises an operating system 310, a print manager 312, and a commercial content database 314. The operating system 310 controls the execution of other programs and provides scheduling, input-output control, file and data management, memory management, and communication control and related services.

In some examples, the print manager 312 is configured to control printing of electronic document content. Such control includes control over the format of the electronic document content as well as control over what commercial content is to be added to a printout of the electronic document content. In the illustrated example, the print manager 312 comprises various modules, including a content extractor 316 that extracts relevant electronic document content from the electronic document content, a content analyzer 318 that determines the underlying subject matter or taxonomic information of the electronic document content and identifies relevant commercial content, and a document generator 320 that creates and formats a new, printable document for printing that comprise both the relevant electronic document content and the relevant commercial content. In some examples, the electronic document content extraction inherently non-relevant content, e.g., footers, headers,source formatting, comments and/or annotations, citations, web site navigation features hyperlinks to other web pages, and online advertisements, and the like from the electronic document. The commercial content added to the document can be obtained from the commercial content database 314, which stores and categorizes various commercial content (e.g., advertisements and/or coupons) available for addition to documents to be printed. As explained in more detail below, the content analyzer 318 executes instructions to use meta-data associated with the various commercial content in the commercial content database including location, demographic, revenue meta-data, to select relevant commercial content to add to the new, printable electronic document.

Example systems having been described above, operation of the systems are now discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

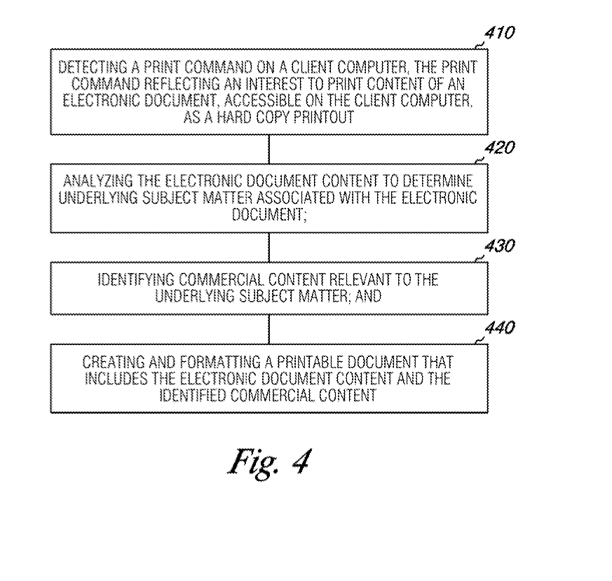

FIG. 4 illustrates an example method for adding commercial content to an electronic document printout. In some examples, the method described in relation to FIG. 4 can be performed on the client computer 102, on the server computer 104, or a combination of both. Beginning with block 410, the method includes detecting a print command on a client computer, the print command reflecting an interest to print content of an electronic document assessable on the client computer as a hard copy printout. In one or more examples, detecting a print command can be performed using a browser printing component as part of browser application code. A browser printing component may be displayed as print buttons with a browser window (print-link), a print button within a browser tool bar or browser menus, etc.

In block 420, the method includes analyzing the electronic document content to determine underlying subject matter associated with the electronic document. As described above, the electronic document may include relevant electronic document content that the user wishes to preserve in the hard copy printout (e.g., certain underlying subject matter and/or theme) as well as other non-relevant electronic document content that forms part of the electronic document but that the user does not wish to preserve, e.g., footers, headers, source formatting, comments and/or annotations, citations, image or photo background, web site navigation features, hyperlinks to other web pages, and online advertisements, and the like. The relevant electronic document content may comprise, for example, one or more of a written article, a graphic, or an image that is the central subject or focus of the electronic document. The undesired content may comprise one or more extraneous features of the electronic document, such as mentioned above.

Such analysis can be performed by using the commercial content plug-in, content extractor, or a combination of both, to execute instructions to determine underlying subject matter associated with the electronic document. By way of example, if the desired content comprises a written article, the analysis can comprise analysis of the words, phrases, or sentences used in the article to determine one or more themes of the article. Additionally, if the desired content is a graphic or image, analysis can comprise analysis of tags associated with the graphic or image that describe it or direct analysis of the image data (e.g., pixels) of the graphic of image to determine the subject of the graphic or image.

In at least one example, the plug-in content extractor, or a combination of both first executes instructions to create a document object model (DOM) data structure for content analysis and extraction. The DOM, for example, can analyze the cluster of contiguous paragraphs together and the cluster with the largest number of paragraphs, in terms of character count, can be chosen as the text block to an electronic document. Within this text block, the plug-in, content extractor, or a combination of both, can then execute additional instructions to further prune out non-relevant content, e.g., icons and link-lists, and to discriminate between add and article images. In one example text electronic document, the outcome of the electronic document content analysis consists of the following components: the article text body, title, associated relevant images and captions, etc, in block 430, the method includes identifying commercial content relevant to the underlying subject matter. In one car more examples, such analysis can be performed by using the commercial content plug-in, content analyzer, or a combination of both, to execute instructions to perform a taxonomic analysis on the underlying subject matter and/or theme associated with the electronic document.

In at least one example, the content analyzer associated with a server computer, e.g., add server, executes instructions to use meta-data associated with the various commercial content in the commercial content database of the server computer, including location, demographic, revenue, and the like meta-data, to select relevant commercial content to add to the new, printable electronic document.

By way of example and not by way of limitation, a data set of advertisements and coupons along with the necessary meta-data or features for contextual matching can be preprocessed by tokenization, stop word removal, and word stemming. Each document is then represented as a token vector, where each element is the TF-IDF (term frequency-inverse document frequency) of the token. Those token vectors can be further processed with a feature selection algorithm to reduce the dimension. A support vector machine (SVM) can be used as the classification method. The SVM is a classifier for binary classification tasks, but it can be extended to address the multi-class classification tasks by combining the results of multiple binary classifiers.

In block 440, the method includes creating and formatting a printable document that includes the electronic document content and the identified commercial content. Irrespective of the manner of analysis that is performed, commercial content is then identified that is relevant to the determined underlying subject matter based on a taxonomic analysis and using meta-data associated with the various commercial content in the commercial content database including location, demographic, revenue meta-data and the like, to select relevant commercial content to add to the new, printable electronic document.

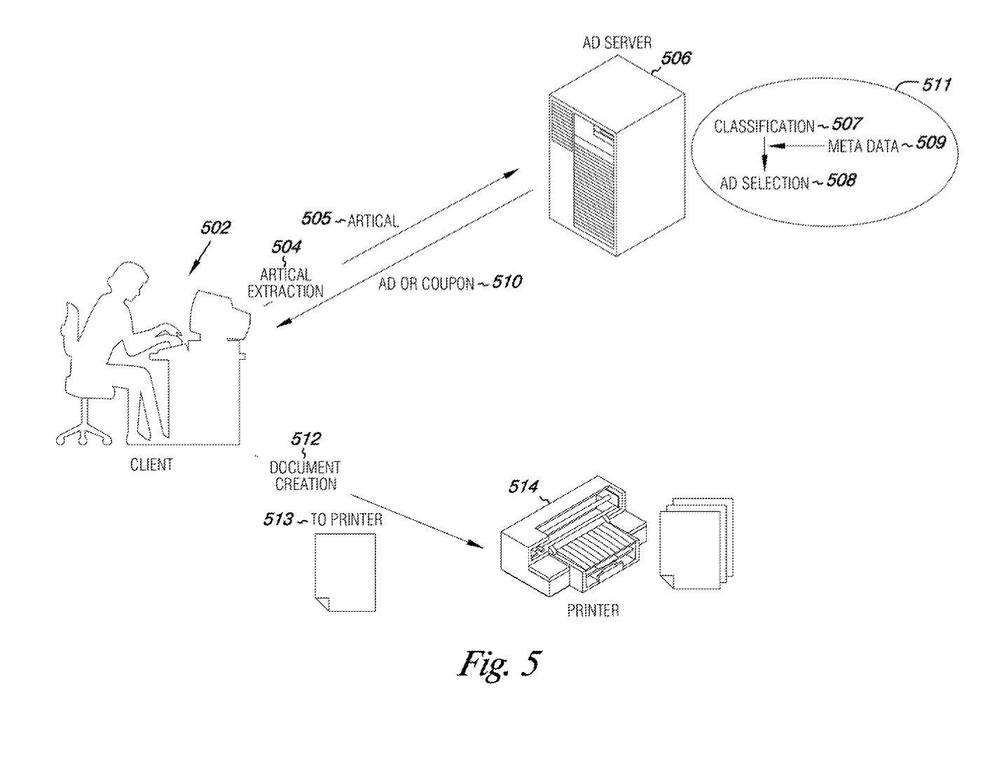

FIG. 5 illustrates an example method for creating a new, printable electronic document that includes commercial content. More particularly, FIG. 5 illustrates a client-centric method for adding the commercial content in which software and/or hardware in the form of application specific integrated circuits (ASICs), in the/or form of a commercial content plug-in (e.g., plug-in 216 of FIG. 2) on the client device, performs analysis on desired content.

Beginning with block 500 of FIG. 5, the commercial content plug-in detects a print command received by the client computer, at block 502. The print command can have been entered by the client computer user by selecting a “print” button or “print” command comprised by the network link. Detection of the command is facilitated by the fact that the commercial content plug-in forms part of the network link and therefore has intimate knowledge of commands received by the network link. Once the print command is detected, the commercial content plug-in identifies the electronic document content that the user wishes to preserve as a hard copy printout, as indicated at 502. In some examples, such identification comprises identifying the underlying subject matter or theme to the electronic document, as has been described above, content of the electronic document, e.g., article extraction 504, the user viewed when the print command was received. Such content may comprise the bulk of the electronic document and/or may be located within the electronic document. In some examples, the underlying subject matter and/or theme can be identified by one or more tags that highlight the main content as such. And sent to an add server, e.g., server 104 in FIG. 1.

Once the relevant electronic document content is identified 505, the commercial content browser plug-in analyzes that content to determine its underlying subject matter executing instructions to perform a taxonomic analysis on the information, as indicated in block 504, to extract an article 505.

At this point, the commercial content plug-in executes instructions to query a database of commercial content 506, e.g., based on a further taxonomic analysis 507, to identify commercial content, for example advertisements and/or coupons, that is pertinent to the determined underlying subject matter. In some examples, such searching comprises the commercial content plug-in sending a search query to the server computer (e.g., add server computer 104 of FIGS. 1 and 3) that controls the database. In at least one example, such a search query can comprise meta-data 509 associated with the various commercial content in the commercial content database including location, demographic, revenue meta-data and the like to identify the type of commercial content 511 that would be relevant. In such examples, the central server computer can reply with commercial content, for instance in the form of one or more advertisements and/or coupons, that are relevant to the electronic document content. For example, if it is determined that the desired electronic document content relates to a particular travel destination, relevant commercial content may comprise advertisements for hotels at that destination and/or coupons for rental cars available at that location.

As shown in block 510, the commercial content plug-in can receive commercial content to be printed along with the electronic document content. The commercial content plug-in can then create and format a document comprising both the electronic document content and the received commercial content 510. Then, with reference to block 512, the commercial content plug-in provides the new, printable electronic document 513 to the browser printing component for translation and transmission to the printing device 514 that generates the hard copy printout.

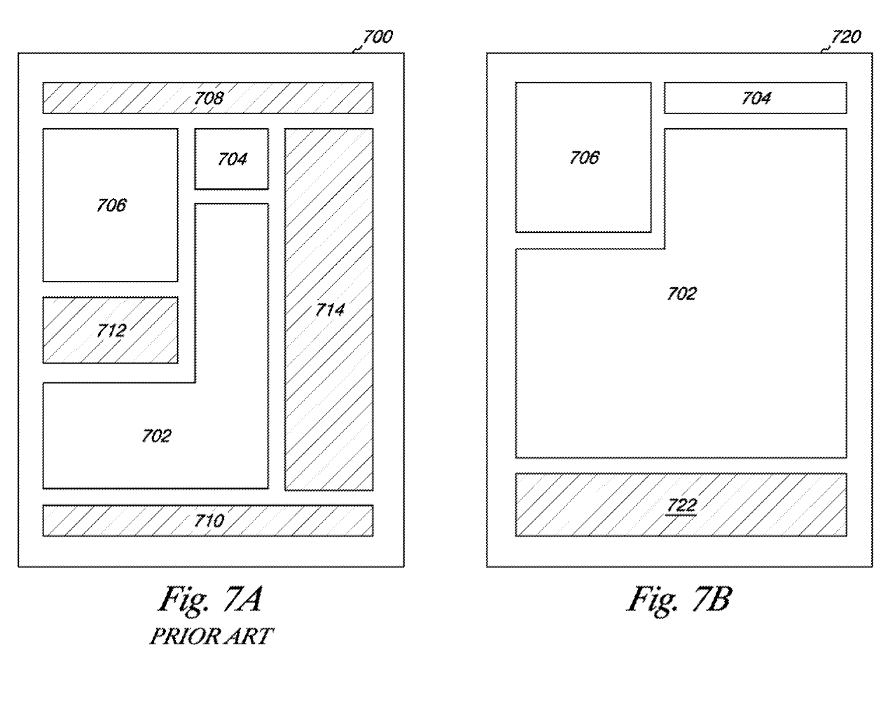

In some examples, the new, printable electronic document includes only or nearly only the electronic document content and the received commercial content, and therefore excludes much or all of the irrelevant electronic document content. With the exclusion or filtering of that extraneous electronic document content, a cleaner, better formatted printout results. FIGS. 7A and 7B illustrate this point. FIG. 7A is a schematic view of an electronic document 700 of an example hard printout that would result when an electronic document is printed in the conventional manner. As shown in that figure, the electronic document 700 comprises a written article 702 and an associated title 704 and photograph 706. Presumably, a user would like to preserve each of those elements when printing. Also appearing in the electronic document 700, however, is various extraneous electronic document content, e.g., in the instance of a web page this would include navigation bars 708 and 710 and online advertisements 712 and 714, and/or other non-relevant electronic document content, e.g., footers, headers, source formatting, comments and/or annotations, citations, and the like. As can be appreciated from FIG. 7A, the electronic document content (i.e., elements 702, 704, 706) accounts for about half of the available space of the electronic document 700. Moreover, because so much of the available space is occupied by non-relevant electronic document content, the article 702 may not fit on the single page printout 700 and may therefore run on to multiple other pages that may also comprise various non-relevant electronic document content, e.g., footers, headers, source formatting, comments and/or annotations, citations, and the like.

FIG. 7B is a is a schematic view of a 720 of an example new, printable electronic document printout that could result when the electronic document that provided content for the electronic document 700 is printed using the systems and methods described herein. As with the electronic document 700, the electronic document 720 comprises the written article 702 and its associated title 704 and photograph 706. Unlike the electronic document 700, however, the electronic document 720 excludes the non-relevant electronic document content including the footers, headers, source formatting, comments and/or annotations, citations, and the like, navigation bars 708 and 710 and the online advertisements 712 and 714. As is further illustrated in FIG. 7B, the new, printable electronic document 720 includes the received commercial content 722, which in the example of FIG. 7B is positioned adjacent the bottom edge of the electronic document below the article 702 As can be appreciated from comparison of FIGS. 7A and 7B, the printout that results using the disclosed systems and methods is formatted much more desirably even with the inclusion of the commercial content 722. Although the commercial content 722 has been shown provided along the bottom edge of the electronic document in FIG. 7B, it is to be appreciated that the commercial content could be placed in any other location on the electronic document, including on the reverse side of the electronic document where double-sided printing is available. In some examples, relatively unobtrusive positioning of the commercial content is beneficial so as to not unduly detract from the relevant electronic document content.

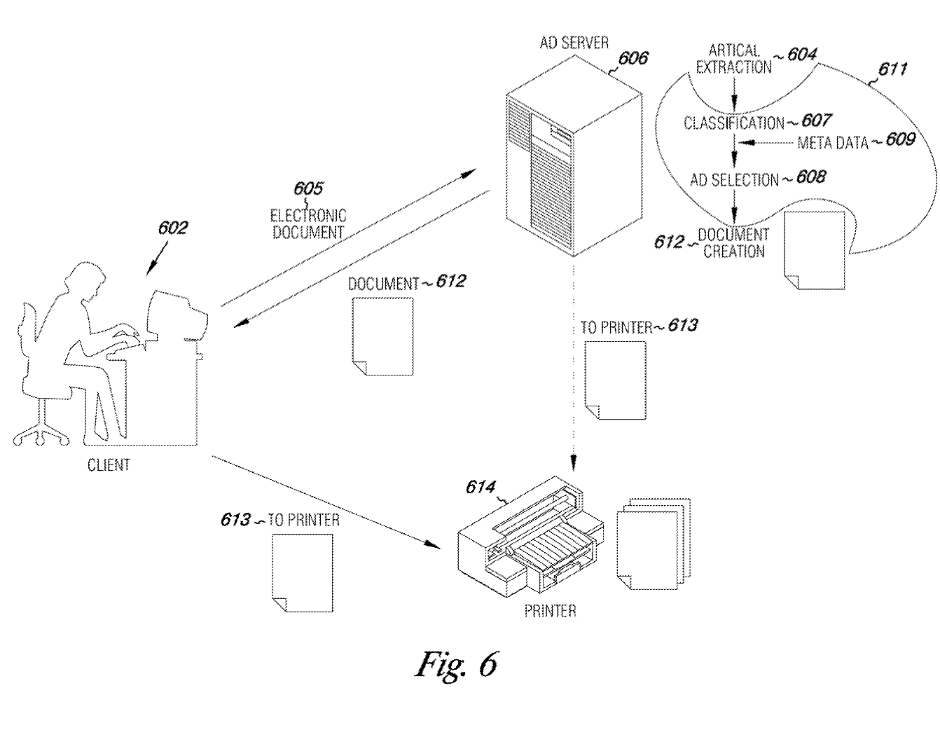

FIG. 6 illustrates an example of a server-centric method for adding commercial content to an electronic document printout. In the example of FIG. 6, a server-centric method is used in which a server computer, e.g., add server, receives an identification of a electronic document 605 that is to be printed from a client computer 602 and creates a document 612 for printing that includes the underlying subject matter of the electronic document and relevant commercial content. Beginning at 602 of FIG. 6A, a network link executing on a client computer 602 detects a print command entered by a user. In some examples, the detection is made by a commercial content plug-in that forms part of the network, link (e.g., 214 and 216 in FIG. 1). The network link (e.g., commercial content plug-in) then sends an identification of the electronic document 605 that was accessible when by the client computer 602 when the print command was received to the server computer 606. In some examples, the identification comprises a uniform resource locator (URL) of the electronic document.

At 604 the server computer 606 receives the electronic document 605 and executes instructions 611 to analyze the electronic document content to determiner underlying subject matter associated with the electronic document, as the same has been described above. That is, instructions can be executed to perform a taxonomic analysis 607 on the received electronic document. In at least one example the server computer 606 additionally executes instructions to use eta-data 609 associated with the various commercial content in a commercial content database including location, demographic, revenue meta-data, to select relevant commercial content 608 to add to the new, printable electronic document 612. In one or more examples, the server computer can identify the electronic document content that is relevant, e.g., that the user wishes to preserve, and generate the same as a hard copy printout, as indicated at 613.

As before, such relevant electronic document content identification 604 comprises identifying the main content of the electronic document. Once the electronic document content is identified, the server computer analyzes, e.g., using taxonomic analysis and meta-data 609 associated with the various commercial content in a commercial content database including location, demographic, revenue meta-data, to select relevant commercial content 608 to add to the new, printable electronic document 612. The database of commercial content can contain, for example, advertisements and/or coupons, that are relevant to the determined underlying subject matter, to result in a new printable document 612.

At 613, the server computer and/or the client computer can send the new, printable document 612 to a printer 614. That is in this example, the client computer can field the new, printable document 612 and send to a printer 614 for printing or the server computer can send the new, printable document 612 to a printer 614 for printing.

In the methods described above, revenue can be generated by the placement of the commercial content on the electronic document printouts. In some examples, the central server computer or other device that controls access to the commercial content database can track which pieces of commercial content are used and how often and can therefore can determine what to charge the advertiser in a per-print scenario.

It is noted that, in some examples, the user can opt-in or opt-out with respect to commercial content being added to his or her electronic document printouts. Incentives may be provided, however, to encourage opting in. For example, in a pay-for-printing scenario, printing fees may be discounted or waived in cases in which the user agrees to the inclusion of commercial content on his or her electronic document printouts.

We claim:

1. A method performed using a physical computer system comprising at least one processor for adding commercial content to electronic document printouts, the method comprising:
detecting a print command on a client computer, the print command reflecting an interest to print content of an electronic document, accessible on the client computer, as a hard copy printout;
analyzing the electronic document content to determine underlying subject matter associated with the electronic document;
identifying commercial content relevant to the underlying subject matter; and
creating and formatting a printable document that comprises the electronic document content and the identified commercial content.

2. The method of claim 1, wherein detecting a print command comprises a content plug-in associated with a network link detecting the print command.

3. The method of claim 2, wherein analyzing the electronic document content comprises the content plug-in analyzing the electronic document content.

4. The method of claim 2, wherein analyzing the electronic document comprises a server computer remote to the client computer analyzing the electronic document content.

5. The method of claim 1, wherein analyzing the electronic document content comprises using a taxonomic analysis to determine a theme of the electronic document.

6. The method of claim 5, wherein analyzing the electronic document content comprises analyzing a graphic or image of the network electronic document.

7. The method of claim 5, wherein identifying commercial content comprises searching a database of commercial content for commercial content that is relevant to the electronic document content based on the taxonomic analysis of the electronic document and using meta-data associated with various commercial content in the database of commercial content.

8. The method of claim 5, wherein creating and formatting the printable document comprises creating a printable document that excludes content not relevant to the theme of the electronic document.

9. The method of claim wherein creating and formatting the printable document comprises positioning the identified commercial content adjacent a bottom edge of the electronic document.

10. A non-transitory computer-readable medium that stores computer executable instructions that are executable by a processor to cause a computing device to perform a method, the method comprising:
detecting a print command on a client computer, the print command reflecting an interest to print content of an electronic document displayed on the client computer as a hard copy printout;
analyzing the electronic document content to determine underlying subject matter associated with the electronic document;
identifying commercial content relevant to the underlying subject matter; and
creating and formatting a printable document that comprises the electronic document content and the identified commercial content.

11. The computer-readable medium of claim 10, wherein the method further comprises using a content plug-in, associated with a network link, to:
detect the print command;
execute instructions to perform a taxonomic analysis on the electronic document content; and
field identified commercial content based on the taxonomic analysis and meta-data associated with various commercial content in a database of commercial content.

12. The computer-readable medium of claim 10, wherein the method further comprises using a content plug-in, associated with a print manager, to:
detect the print command;
execute instructions to extract content relevant to the underlying subject matter;
send the extracted content to a server computer remote to the client computer for performing a taxonomic analysis on the extracted content together with using meta-data associated with various commercial content in the database of commercial content to create and format the printable document; and
field the return printable document.

13. A network computing device, comprising:
a processor;
a memory coupled to the processor, wherein the memory stores computer executable instructions which are executed by the processor to:
detect a print command on a client computer, the print command reflecting an interest to print content of an electronic document, accessible on the network computing device, as a hard copy printout;
analyze the electronic document content to determine underlying subject matter associated with the electronic document;
identify commercial content relevant to the underlying subject matter; and
create and format a printable document that comprises the electronic document content and the identified commercial content.

14. The network computing device of claim 13, wherein the memory tares computer executable instructions which are executed by the processor to:
send the underlying subject matter to a remote commercial content database;
request the remote commercial content database to identify commercial content relevant to the underlying subject matter using a taxonomic analysis and using meta-data associated with various commercial content in the commercial content database; and
field the identified commercial content from the remote commercial content database.

15. The network computing device of claim 13, wherein the memory stores computer executable instructions which are executed by the processor to request a remote commercial content database to identify pre-archived commercial content relevant to the underlying subject matter using a taxonomic analysis and using location and demographic meta-data associated with various commercial content in the commercial content database.
